(19) United States
(12) Patent Application Publication
(10) Pub. No.: US 2006/0285932 A1
(43) Pub. Date: Dec. 21, 2006

(54) Core drill assembly with the ability to control angle of drilling

(75) Inventor: No-hwan Park, Seoul (KR)

Correspondence Address: STETINA BRUNDA GARRED & BRUCKER, 75 ENTERPRISE, SUITE 250, ALISO VIEJO, CA, 92656, US

(73) Assignee: Cabel Co. LTD

(21) Appl. No.: 11/429,908

(22) Filed: May 8, 2006

(30) Foreign Application Priority Data
Jun. 17, 2005 (KR) 10-2005-0052454

(51) Int. Cl. B23B 45/14

(52) U.S. Cl. 408/110

(57) ABSTRACT

A core drill assembly provided for drilling on a surface at select angles capable of drilling both away from and towards the base. The surface that the core drill assembly is deployed upon defines a surface plane. The core drill assembly comprises a base deployable upon a surface. The base having first and second opposing ends and a base axis extending from the first end of the base to the second end parallel to the surface plane. The core drill assembly including a stand defining a stand longitudinal axis intersecting the base axis. The stand is pivotally connected to the base and angularly positionable between acute and obtuse angles defined between the stand longitudinal axis and the base axis with respect to an angular direction away from the surface plane towards the base axis. A drill motor including drill bit is coupled to the stand.

### CROSS-REFERENCE TO RELATED APPLICATIONS

This application claims benefit under 35 U.S.C. §119 from Korean Patent Application No. 10-2005-0052454, entitled ELECTRIC CORE DRILL MACHINE, filed on Jun. 17, 2005, the entire content of which is incorporated herein by reference.

### STATEMENT RE: FEDERALLY SPONSORED RESEARCH/DEVELOPMENT

Not Applicable

### BACKGROUND OF THE INVENTION

The present invention relates to a core drill assembly used to bore through the surface it is deployed upon. More particularly, the invention is directed to a device useful for drilling upon a surface at angles adjustable to allow the drill to bore towards, away, or perpendicular from the base of the device.

The traditional core drill assembly is a mechanical device used as a tool to bore through certain materials. The core drill assembly generally consists of a base, the base being fixed to the surface to be bored by bolts. The core drill assembly includes a stand perpendicular to the base, a driving body that moves longitudinally along the stand by rotating a handle, and a core drill machine attachable to the driving body. The core drill machine includes a bit to bore the surface using friction and the drill motor to rotate the bit spin at a high speed.

The core drill assembly functions by deploying the base onto a surface. Activating the drill motor to cause the drill bit to spin at a high speed and then rotating the handle to lower the drill bit for drilling through the surface.

While such a core drill assembly is useful for drilling surfaces at a perpendicular angle with respect to the base, the traditional core drill assembly cannot drill at any other angle but the perpendicular. This presents a problem for those users who desire to bore or drill through a surface at an angle not perpendicular to the base of the device.

To solve this problem, core drill assemblies began implementing an angle regulator. The angle regulator attaches to the base of the core drill assembly using a fixed bracket installed to fix the stand between two flanges located on each side of the base. An axis of rotation penetrates the flanges and the fixed bracket. A rotation controller is installed on one side of the axis of rotation to control the rotation angle of the fixed bracket. The end of the axis of rotation is threaded to fix the fixed bracket with a fixed nut tightened to the threaded end of the axis of rotation.

The rotation controller of the angle regulator has two discs to form spline ball on one flange and one side of the fixed bracket, and another spline corresponding to the spline ball of the discs on the side of the axis of rotation to insert the spline in the spline ball, controlling the rotation angle of the fixed bracket to a certain angle. Despite the addition of an angle regulator to the core drill assembly, there are problems when drilling at an angle.

The angle regulator includes a complicated process that requires the user to set the angle of the core drill assembly after pulling out of the axis of rotation. Then the user must match the spline of the axis of rotation with the spline ball to fix the core drill assembly. This process makes it very difficult to fix the angle at which the user would like to drill.

Additionally, the angle regulator of a contemporary core drill assembly is limited in the selection of drilling angles. The diameter of the axis of rotation is too small, preventing the spline from being divided more systematically and limiting the selection of angles that the core drill assembly can drill. The traditional technology that controls the angle of the core drill by matching spline with spline ball may form a gap between the spline and the spline ball. The gap can be dangerous because it could cause the drill to shake during the boring process and break away from the original rotation angle or significantly pose a risk to the safety of the user or others in close proximity to the drill. Besides the problems discussed above, the angle regulator is not capable of setting the drilling angle at an angle greater than the perpendicular or 90 degrees. In other words, the drill is not capable of drilling towards the base at an angle. The core drill assembly with contemporary angle regulators is only capable of drilling away from the base at an angle.

Accordingly, it is desirable to provide a core drill assembly that can regulate the angle of drilling beyond a perpendicular angle. There is a need for a core drill assembly capable of drilling towards the base of the device at an angle. It is further desirable to select from a variety of preselected angles at which to drill. As such, a user should also have the reassurance that drilling at an angle whether it is towards or away from the base will be safe and secure.

### BRIEF SUMMARY OF THE INVENTION

In accordance with the present invention, a core drill assembly is provided for drilling upon a surface. The surface defining a surface plane. The core drill assembly includes a base configured to be deployable on the surface. The base includes opposing first and second ends. The base having an axis that extends from the first end towards the second end of the base. The base axis is parallel to the surface plane. Furthermore, the core drill assembly includes a stand defining a stand longitudinal axis that intersects the base axis. The stand is pivotally connected to the base. The stand is angularly positionable between acute and obtuse angles. The angles are defined between the stand longitudinal axis and the base axis with respect to an angular direction away from the surface plane towards the base axis. A drill motor is coupled to the stand and longitudinally translatable along the stand. A drill bit is attached to the drill motor. The core drill assembly is operative to adjust the angle of the stand to drill securely either away from or towards the base of the core drill assembly.

The core drill assembly is operative to angularly position the stand between preselected angles for drilling. The angles are defined between the stand longitudinal axis and the base axis with respect to an angular direction away from the surface plane and towards the base axis. The embodiment of the invention has the advantage of selecting different angles without requiring a complicated process that requires the user to set the angle of the core drill after pulling out of the axis of rotation and match the spline of the axis of rotation with the spline ball to fix the core drill assembly.

The core drill assembly is operative to angularly position the stand between angles of equal interval.

The core drill assembly is operative to angularly position the stand to preselected angles between 60 and 120 degrees. The range of angles is defined between the stand longitudinal axis and the base axis with respect to an angular direction away from the surface plane and towards the base axis. The embodiment has the advantage of selecting from a range of angles to drill both away from and towards the base of the core drill assembly as well as perpendicular to the base.

The core drill assembly having a drill motor defining a drill longitudinal axis. The drill longitudinal axis is parallel to the stand longitudinal axis. The embodiment of the invention has the advantage of the drilling angle equal to the angle between the stand longitudinal axis and the base axis.

The core drill assembly having two disc structures. The two disc structures having ribbed boundaries. The two disc structures are disposed between the base and the stand holder. The embodiment has the advantage of securely adjusting between preselected angles of drilling.

The core drill assembly having two disc structures with ribbed boundaries that interlock and engage the stand holder and the base at a preselected angle. This embodiment of the invention has the advantage of securing the angle of drilling of the core drill assembly.

### BRIEF DESCRIPTION OF THE DRAWINGS

FIG. 1 illustrates a side view of a core drill assembly formed in accordance with the present invention;

FIG. 2 illustrates a side view of a core drill assembly with the stand positioned at an obtuse angle;

FIG. 3 illustrates a side view of a core drill assembly with the stand positioned at an acute angle;

FIG. 4 illustrates a top plan view of the core drill assembly;

FIG. 5 illustrates a top plan view of the base of the core drill assembly;

FIG. 6 illustrates a sectional view of the inside angle regulator of the core drill assembly;

FIG. 7 illustrates a sectional view of the outside angle regulator of the core drill assembly;

FIG. 8 illustrates a top plan view of the core drill assembly with angle scale and angle pointer;

FIG. 9 illustrates a top plan view of the drill angle regulator prior to controlling the angle of the device; and

FIG. 10 illustrates a top plan view of the drill angle regulator subsequent to controlling the angle of the device.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

According to the embodiment as shown a core drill assembly 100 for use on a surface 11. The surface 11 defining a surface plane 13. The core drill assembly 100 comprising a base 10 configured to be deployable on the surface 11. The base 10 having opposing first and second ends with a base axis 15 extending from the first end towards the second end of the base 10 and parallel to the surface plane 13. A stand 18 defining a stand longitudinal axis 17 intersecting the base axis 15. The stand 18 is pivotally connected to the base 10 and angularly positionable between acute and obtuse angles defined between the stand longitudinal axis 17 and the base axis 15 with respect to an angular direction away from the surface plane 13 towards the base axis 15. A drill motor 30 coupled to the stand 18 and longitudinally translatable along the stand and a drill bit 28 attached to the drill motor 30.

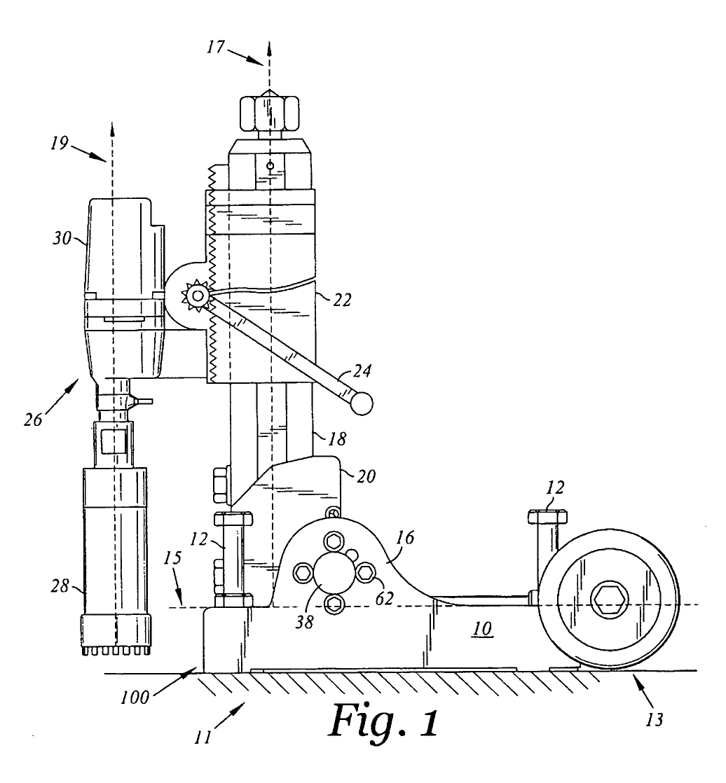

In further detail referring to FIG. 1, the core drill assembly 100 includes a base 10 deployable on a surface 11 to bore by fixed bolts 12 and has two bulged flanges 14, 16 on both sides of the base 10. The stand 18 meets the base 10 at a right angle. The stand holder 20 is equipped to the lower part of the stand 18 and is inserted between the two flanges 14, 16 of the base 10 to fix the stand 18 on the base 10. The driving body 22 includes a pinion gear matched with the stand 18 and moves longitudinally along the stand 18 by rotation of the handle 24. The core drill machine 26 is equipped to the driving body 22. The core drill machine 26 includes the drill bit 28, which bores the surface 11 using friction between the drill bit 28 and the drill motor 30, which rotates the bit 28 at a high speed.

According to the embodiment as shown the stand 18 of the core drill assembly 100 is angularly positionable between preselected angles defined between the stand longitudinal axis 17 and the base axis 15 with respect to an angular direction away from the surface plane 13 towards the base axis 15. The core drill assembly 100 has the ability to control the angles at which to drill by using an angle regulator. In further detail referring to FIG. 5, holes 32, 34 are formed on the bulged flanges 14, 16 on both sides of the base 10. The transport pipe 36 is formed on the stand holder 20, which is inserted between the flanges 14, 16. The transport pipe 36 of the stand holder 20 penetrates through the holes of the flanges 14, 16. The fixed shaft 38 with thread at the end is inserted through the hole 34 of the base 10, the transport pipe 36, and the other hole 32 of the base 10. The stand holder 20 linked with fixed nut 40 at the threaded end of the fixed shaft 38 is fixed between the flanges of the base 14, 16.

According to the embodiment as shown the core drill assembly 100 includes two disc structures that form the inside and outside angle regulators 42, 50. The boundaries of the angle regulators are ribbed. The outside and inside angle regulators are disposed between the base 10 and the stand holder 20. The ribbed boundaries of the angle regulators 42, 50 interlock to engage the stand holder 20 and the base 10 at a preselected angle.

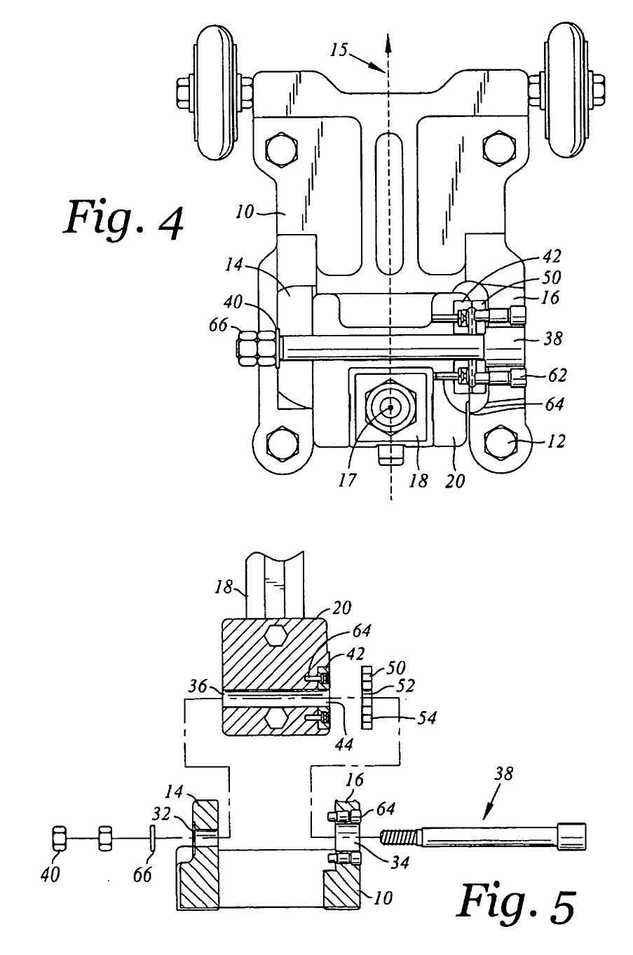

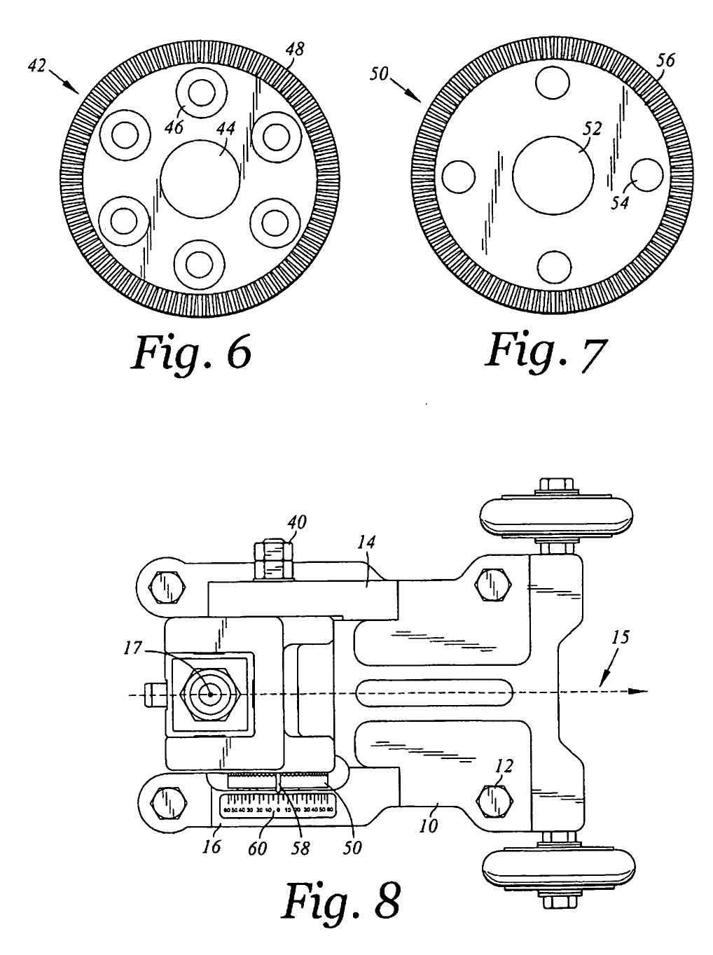

In further detail referring to FIGS. 4-7, the inside angle regulator 42 is attached to one side of the stand holder 20. The inside angle regulator 42 has disc structure which forms through hole 44 with the transport pipe 36 in the center. Boltholes 46 are located around the through hole 44. The boundary of the inside angle regulator 42 is ribbed to form gear tooth unevenness 48. As a result the bolts 64 are matched with the boltholes 46 when the fixed shaft 38 is inserted in the through hole 44, and the inside angle regulator 42 is then fixed on one side of the stand holder 20.

The outside angle regulator 50 is attached on the inside of flange 16 of the base 10. The outside angle regulator 50 has disc structure similar to the inside angle regulator 42. The through hole 52 in the center is linked with the through hole of the inside angle regulator 44 and one of the flanges 16. Around the through hole 52, boltholes 54 are formed. The boundary of the outside angle regulator 50 is ribbed to form gear tooth unevenness 56. The ribbed portion of the outside angle regulator 50 should be matched with the ribbed portion of the inside angle regulator 42 and the boundaries of both the inside and outside angle regulator 42, 50 should be divided systematically. If bolts 64 are inserted through the bolt holes 54 in the condition that the fixed shaft 38 is inserted in the through hole of the center 52, the outside angle regulator 50 becomes fixed on the inside of the flange 14.

According to the embodiment as shown the stand 18 of the core drill assembly 100 is angularly positionable between equal intervals. The stand 18 is angularly positionable between a range of 60 and 120 degrees. The angle of the stand 18 is defined between the stand longitudinal axis 17 and the base axis 15 with respect to an angular direction away from the surface plane 13 and towards the base axis 15.

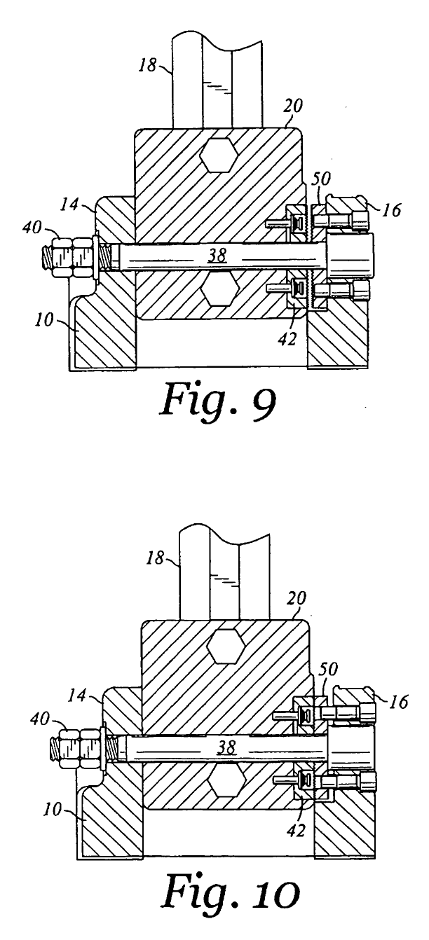

In further detail referring to FIGS. 8-10, the angle regulator can adjust the drilling angle of the core drill assembly 100 by matching the ribbed portions of both the inside and outside angle regulators 42, 50. This method of controlling the angle is more sophisticated, because the inside and outside angle regulators 42, 50 have a greater diameter than the fixed shaft 38. The fixed shaft 38 cannot divide the surface of circumference into more than 24 intervals, limiting the adjustment of angles to 15 degrees per interval. The inside and outside angle regulators 42, 50 can divide the surface of the circumference into 72 intervals for adjusting the angle in increments of 5 degrees per interval.

The stand holder 20 with the inside angle regulator 42 is inserted between the flanges 14, 16 of the base. The fixed shaft 38 is set through the through hole of the one flange 16, the through holes of the inside and outside angle regulators 44, 52, the transport pipe 36 of the stand holder 20, and the through hole of the other flange 14. The fixed nut 40 and the washer 66 are attached to the end of the fixed shaft 38. The stand 18 and the stand holder 20 cannot break away from the base 10 or rotate freely without it, because the ribbed portion of both the inside and outside angle regulators interlock.

The angle scale 60 has 5 and 10 degree angle increments. The angle scale 60 is located on one flange 16 with the outside angle regulator 50 to show the angle of the stand 18, and the pointer 58 refers to the angle on the angle scale 60. The angle pointer 58 is located on the stand holder 20 with the inside angle regulator 42 for viewing the angle set to drill. As a result, users can control the angle of the stand 18 accurately, because the user can adjust the stand 18 while observing the pointer 58 and view the angle the core drill assembly 100 is set to.

To adjust the angle of drilling by adjusting the stand 18, the fixed nut 40 at the end of the fixed shaft 38 is released. This is achieved by releasing the fixed nut 40 about 3 or 4 mm, until the interlocked ribbed portions of the inside and outside angle regulators are released. Once the angle regulators are released, the user can adjust the stand 18 to a preselected angle. If the user adjusts the stand 18 while observing the angle scale 60 of the flange referred to by the pointer 58, the user can adjust to achieve the desired angle. After adjusting the stand 18, the user can tighten the fixed nut 40 at the thread end of the fixed shaft 38. The tightening of the fixed nut 40 at the thread end of the fixed shaft 38 will cause the ribbed portions of the inside and outside angle regulators to interlock. The stand 18 is then fixed by the combined angle regulators.

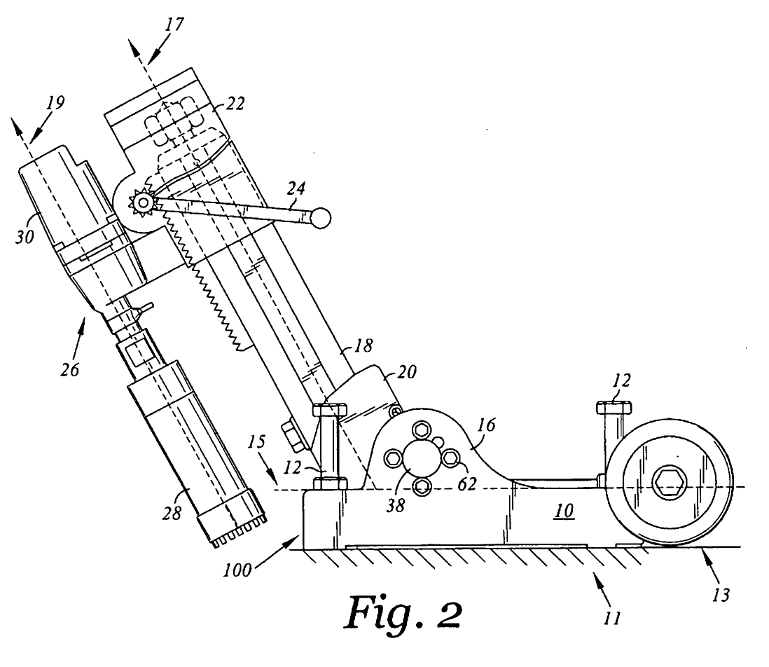

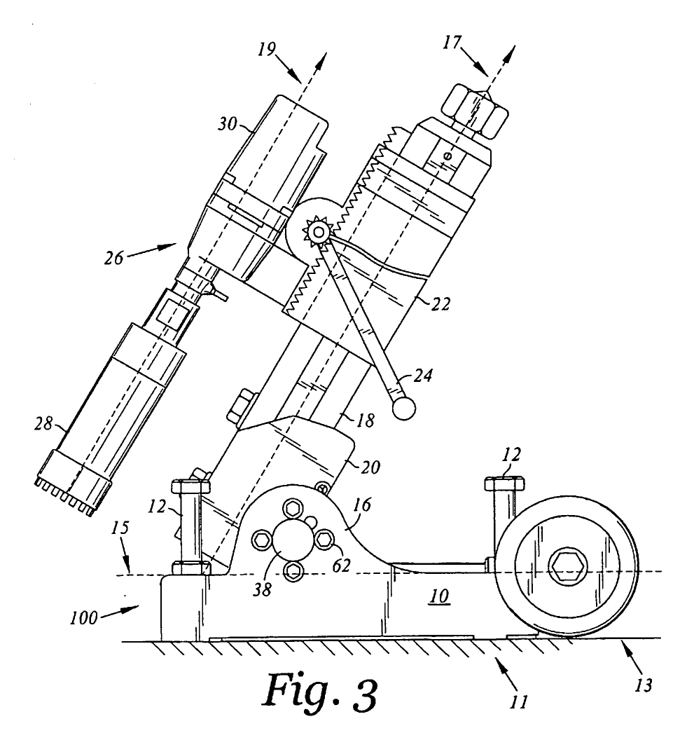

According to the embodiment as shown the drill motor defines a drill longitudinal axis 19 parallel to the stand longitudinal axis 17. In further detail referring to FIGS. 2-3, the angle of the stand 18 is the same as the angle of drilling. Because the core drill machine 26 is equipped to the stand 18 by the driving body 22, the drill longitudinal axis 19 is parallel to the stand longitudinal axis 17. Therefore, the angle of the stand 18 is equal to the angle of drilling. An aspect of the present invention as shown in FIG. 3 is the capability of the core drill assembly 100 to drill the surface 11 with the drill bit 28 directed away from the base 10. This is possible because the angle of the stand is adjusted to form an acute angle with the base. The angle regulators 42, 50 are matched to form an acute angle between the base axis 15 and the stand longitudinal axis 17 in a direction away from the surface plane 13. Referring to FIG. 2 the core drill assembly 100 is capable of drilling the surface 11 with the drill bit 28 directed towards the base 10. The angle of the stand is adjusted to form an obtuse angle with the base and the drilling angle corresponds to the angle of the stand. The angle regulators 42, 50 are matched to form an obtuse angle between the base axis 15 and the stand longitudinal axis 17 in a direction away from the surface plane 13. Thus, allowing the user to drill at an angle toward the base of the core drill assembly.

What is claimed is:

1. A core drill assembly for use on a surface, the surface defining a surface plane, the core drill assembly comprising:
a base configured to be deployable on the surface, the base having opposing first and second ends, a base axis extending from the first end towards the second end of the base and parallel to the surface plane;
a stand defining a stand longitudinal axis intersecting the base axis, the stand pivotally connected to the base and angularly positionable between acute and obtuse angles defined between the stand longitudinal axis and the base axis with respect to an angular direction away from the surface plane towards the base axis;
a drill motor coupled to the stand and longitudinally translatable along the stand; and
a drill bit attached to the drill motor.

2. The core drill assembly of claim 1, wherein the stand is angularly positionable between preselected angles defined between the stand longitudinal axis and the base axis with respect to an angular direction away from the surface plane and towards the base axis.

3. The core drill assembly of claim 1, wherein the stand is angularly positionable between preselected angles of equal interval defined between the stand longitudinal axis and the base axis with respect to an angular direction away from the surface plane and towards the base axis.

4. The core drill assembly of claim 1, wherein the stand is angularly positionable between a range of 60 and 120 degrees defined between the stand longitudinal axis and the base axis with respect to an angular direction away from the surface plane and towards the base axis.

5. The core drill assembly of claim 1, wherein the drill motor defines a drill longitudinal axis parallel to the stand longitudinal axis.

6. The core drill assembly of claim 1, further comprising two disc structures with ribbed boundaries disposed between the base and the stand holder.

7. The core drill assembly of claim 6, wherein the ribbed boundaries of the two disc structures interlock to engage the stand holder and the base at a preselected angle.
